(19) United States
(12) Patent Application Publication
(10) Pub. No.: US 2004/0227645 A1
(43) Pub. Date: Nov. 18, 2004

(54) Break-away motion detector and signal transmitter

(76) Inventors: Kraig M. Lujan, Somis, CA (US); Lex Lujan, Roy, UT (US)

Correspondence Address: GENE W. ARANT, P.O. BOX 269, LINCOLN CITY, OR, 97367-0269, US

(21) Appl. No.: 10/439,994

(22) Filed: May 16, 2003

(51) Int. Cl. H04Q 9/00; G08C 19/22

(52) U.S. Cl. 340/870.07

(57) ABSTRACT

A motion detector and signal transmitter for use in an apparatus for detecting and reporting dislocation of heavy mining equipment. The motion detector has an electromagnetic transducer that detects relative motion between two metal parts that are normally held together in surface engagement.

### RELATED APPLICATION—PRIORITY CLAIM

This application discloses and claims an improvement over the invention disclosed and claimed in our copending U.S. patent application Ser. No. 10/052,289 filed Jan. 18, 2002.

### FIELD OF THE INVENTION

This application relates to control of heavy mining equipment.

### BACKGROUND OF THE INVENTION

In the operation of heavy mining equipment there are situations where two metal parts, normally in surface contact, become accidentally separated or broken apart. For reasons of safety and economy it then becomes important for the machine operator to be immediately alerted to this problem, for reasons as described in more detail in our copending application.

### SUMMARY OF THE INVENTION

An electromechanical transducer mechanism is adapted to generate a radio frequency alarm signal whenever a mining machine is about to lose a metal part that is normally held in surface engagement with another metal part of the machine. The other (and normally stationary) metal part of the machine has a recess in its surface, and an electrical circuit and antenna contained therein which are activated whenever the separation of metal parts occurs so as to generate a radio frequency signal that is then sent to the control station for the mining machine.

According to the presently preferred form of the invention an open-ended metal housing is received in the recess in the other (normally stationary) metal part, and the antenna is normally confined inside the housing. A movable member inside the housing secures the antenna, and a spring which engages the movable member normally urges the antenna to move outward from the housing. An electrical circuit inside the housing is electrically connectable to the antenna. A magnet is secured to the movable member to actuate a switch inside the housing for energizing the electrical circuit and hence the antenna. Thus, upon movement of the metal (potentially losable) member a radio frequency signal generated by the electrical circuit is transmitted from the antenna to a remote location.

Further according to the presently preferred embodiment of the invention the movable member is a lid made of a non-conducting material so that it will not interfere with transmission of the radio frequency signal from the antenna. The lid is preferably pivotably mounted on an open end of the transducer housing.

### DRAWING SUMMARY

FIG. 1 is a vertical cross-sectional view of the end portion of a mining bucket with a tooth assembly attached thereto;

FIG. 2 is a cross-sectional elevation view of a transducer assembly in accordance with the presently preferred form of the invention;

FIG. 3 is a horizontal cross-sectional view taken essentially on the line 3--3 of FIG. 2;

FIG. 4 is a vertical cross-sectional view of the end portion of the mining bucket with tooth assembly detached; and

FIG. 5 is a view like FIG. 2, but schematically showing a partial separation of the tooth assembly, and the action of the antenna when released from the metal housing of the transducer.

### DETAILED DESCRIPTION OF PREFERRED EMBODIMENT

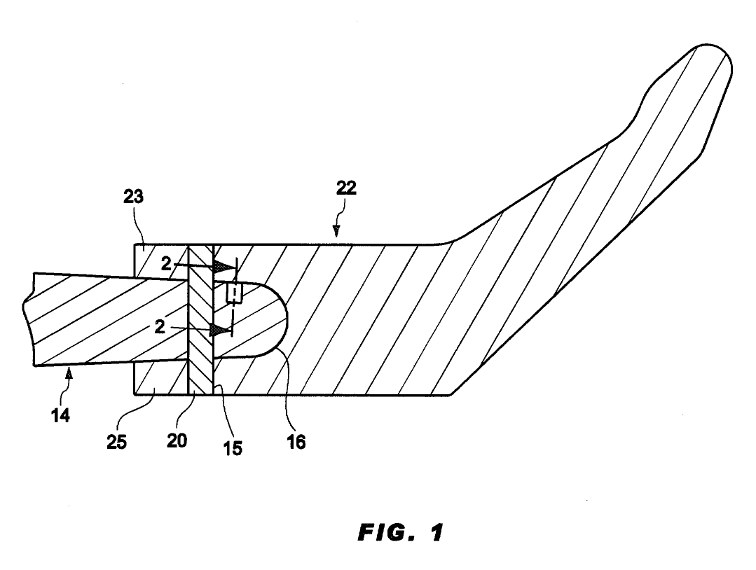

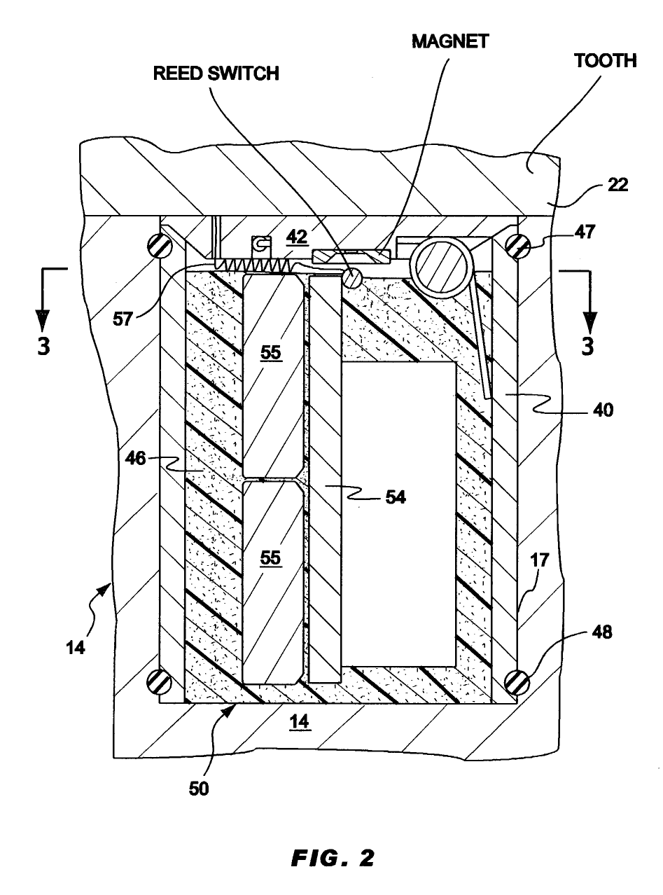

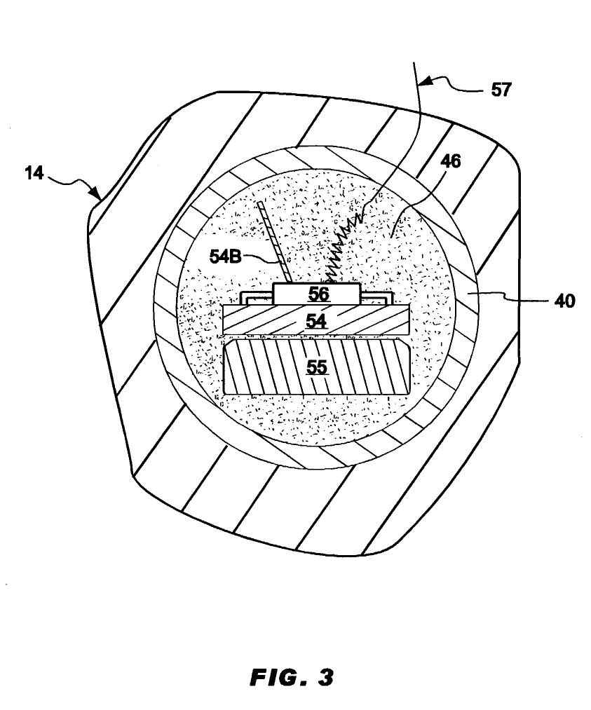

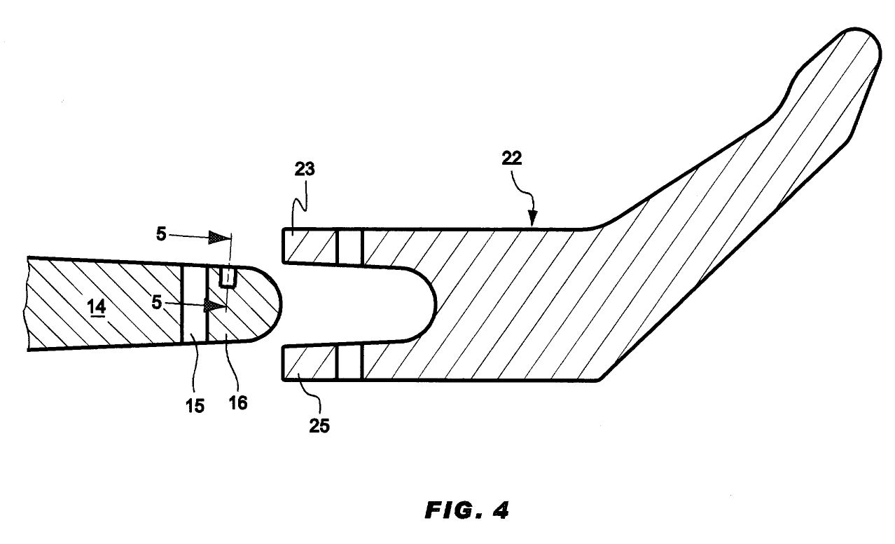

Referring now to the drawings, FIGS. 1 through 5, a mining bucket 14 normally supports an adapter or tooth 22 which is part of one of the tooth assemblies carried by a mining machine, not shown in the present drawings. The forward edge portion of the bucket is designated as 16. A hole 15 which passes through the bucket receives an adapter attachment pin 20 that secures the tooth or adapter 22.

Upper leg 23 of tooth or adapter 22 passes over the bucket 14 while its lower leg 25 passes under the bucket. Aligned holes 28 and 29 in the upper and lower legs of the adapter retain the respective ends of the attachment pin 20.

A recess 17 is formed in the upper surface of the bucket for receiving a transducer assembly 50. In the presently preferred form of the invention the location of the recess 17 is intermediate to the forward bucket edge 16 and hole 15.

Transducer assembly 50 is contained within and/or supported by a cup-shaped metal housing 40. The housing 40 in turn is supported in the recess 17 by upper and lower grommets 47 and 48. A lid member 42 made of an electrically non-conductive material is pivotally supported from one edge of the open upper end of the housing 40.

A circuit board 54 having auxiliary circuit board portion 54B and a battery 55 are contained within the housing 40 and surrounded by spacer or potting material 46. An antenna 57 in the open end of housing 40 is normally confined therein by the upper leg 23 of the potentially losable tooth or adapter 22. The lid member 42 near its outer end supports one end of the antenna 57. A torsion spring 52 engages the lid member 42 and normally urges the antenna to move outward from the housing.

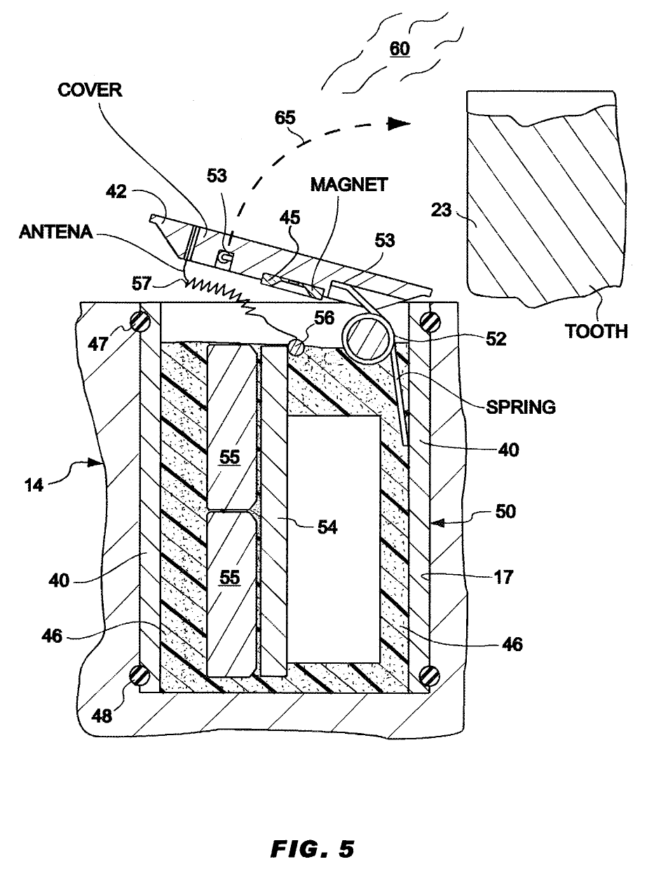

A lower leg of spring 52 is confined within potting compound or spacing material 46, and an upper leg 53 of the spring is received in and secured by the underside of lid 42. The electrical circuit 54 inside the housing is electrically connected to the antenna 57. A magnet 45 is secured to the movable member 42 to actuate a reed switch 56 inside the housing 40 for connecting battery 55 to circuit 54 and hence energizing the electrical circuit and antenna 57. Thus, upon movement of the potentially losable metal member 22 a radio frequency signal 60 generated by the electrical circuit 54 is transmitted from the antenna 57 to a remote location. In FIG. 5 a dotted line 65 schematically indicates the upper leg 23 of tooth 22 as being swung away in an arcuate path, but it will be understood that in fact the break-away movement would normally be a sliding movement.

According to the presently preferred embodiment of the invention the movable member is a lid 42 made of a non-conducting material so that it will not interfere with transmission of the radio frequency signal from the antenna. The lid 42 is preferably pivotably mounted on the open end of the transducer housing 40.

Alternate forms. If a suitable switch can be found that will normally remain in surface contact with the potentially losable metal part during operation of the machine, and will close when that one metal part moves away from it, then a movable member such as the present lid may no longer be required for generating an alarm signal when the one metal part moves away from the other.

What we claim is:

1. In a mining machine having two metal parts that normally remain in surface-to-surface contact during operation of the machine, an electromechanical transducer mechanism for generating an alarm signal whenever one of the metal parts moves away from the other, comprising:
a recess in the surface of the other metal part;
an open-ended metal housing insertable into the recess;
an antenna in the open end of the housing and normally confined therein by the one metal part;
a movable member and a spring normally urging the antenna to move outward from the housing;
an electrical circuit contained within the housing and adapted to generate a radio frequency alarm signal;
a magnet secured to the movable member; and
a magnetically operable switch located within the housing and responsive to the movement of the magnet to electrically energize the electrical circuit so that the antenna after moving free of the metal housing then transmits an alarm signal which is indicative of the separation of the metal parts and which can be transmitted to a remote location.

2. A transducer as in claim 1 wherein the movable member is a lid pivotally mounted on the open end of the housing, being made of an electrically non-conductive material to avoid interfering with the alarm signal transmitted from the antenna.

3. The apparatus of claim 1 wherein:
the open-ended metal housing has an open end flush with the surface of the one metal part;
the movable member is a lid normally closing the open end of the housing and being held closed by the adjacent surface of the one metal part;
a spring within the housing normally urging the lid to open;
the antenna being at least partially secured to the lid, the lid being made of an electrically non-conducting material to avoid interfering with a signal generated from the antenna;
the electrical circuit inside the housing being connected to the antenna to generate a radio frequency alarm signal; and
the lid being pivotally movable in response to the separation of the metal parts so that a radio frequency signal then generated by the electrical circuit will also be transmitted from the antenna.

4. In a mining machine having two metal parts that normally remain in surface contact during operation of the machine, an electromechanical transducer mechanism for generating an alarm signal whenever one of the metal parts moves away from the other, comprising:
a recess in the surface of the other metal part;
a housing insertable into the recess, the housing having a normally open end;
a lid pivotally supported on the open end of the housing;
a spring within the housing normally urging the lid to pivot toward an open position;
an antenna secured to the lid and movable therewith;
a circuit board inside the housing and electrically connected to the antenna;
a battery inside the housing;
a magnetically operable switch located inside the housing and adapted to electrically connect the battery to the circuit board;
a magnet secured to the lid and movable with it; and
the lid being made of a non-conducting material to avoid interfering with signals to be sent from the antenna, whereby upon separation of the metal parts the lid pivots outwardly, the movement of the magnet actuates the switch, and energy is then supplied from the circuit board to the antenna for generating an alarm signal indicative of the separation of the metal parts.

5. In a mining machine having two metal parts that normally remain in surface contact during operation of the machine, an electromechanical transducer mechanism for generating an alarm signal whenever one of the metal parts moves away from the other, comprising:
a recess in the surface of the other of the metal parts;
an antenna at least partially disposed within the recess;
a circuit board inside the housing and electrically connected to the antenna;
a battery inside the housing; and
a switch located within the recess and responsive to movement of the one metal part to electrically connect the battery to the circuit board so that energy is then supplied from the circuit board to the antenna for generating an alarm signal indicative of the separation of the metal parts.
